(19) United States
(12) Patent Application Publication
(10) Pub. No.: US 2026/0365778 A1
(43) Pub. Date: Nov. 19, 2026

(54) HIGH-STRENGTH POLYURETHANE ADHESIVE, METHOD FOR PREPARING THE SAME, AND USE THEREOF

(71) Applicant: QILU UNIVERSITY OF TECHNOLOGY (SHANDONG ACADEMY OF SCIENCES), Jinan (CN)

(72) Inventors: Rong LUO, Jinan (CN); Biru LIN, Jinan (CN); Ziying ZHAO, Jinan (CN); Jiarong GONG, Jinan (CN); Chao ZHOU, Jinan (CN)

(21) Appl. No.: 19/681,199

(22) Filed: May 19, 2026

(30) Foreign Application Priority Data
May 19, 2025 (CN) 2025106381467

(51) Int. Cl. C08G 18/58; C09J 175/04

(52) U.S. Cl. CPC C08G 18/585; C09J 175/04; C08G 2170/00

(57) ABSTRACT

The disclosure relates to a high-strength polyurethane adhesive, a method for preparing the same, and use thereof. The method includes mixing a branched polythiol with an epoxide compound, reacting the mixture in the presence of a catalyst, and terminating the reaction with a neutralizing agent to obtain an epoxide-derived prepolymer. The epoxide-derived prepolymer is mixed with a branched polythiol to form a mixture. The mixture is reacted with an isocyanate to obtain a product, and the product is degassed to obtain the high-strength polyurethane adhesive. By introducing sulfur-containing segments into polymer chains, the adhesive improves adhesion between a base fabric or backing fabric and a coating, and improves water resistance, solvent resistance, and low-temperature resistance. The adhesive is suitable for humid, low-temperature, and organic-solvent environments, and the preparation process is solvent-free.

### CROSS-REFERENCE TO RELATED APPLICATIONS

This application claims priority to Chinese Patent Application No. CN202510638146.7, filed on May 19, 2025, and entitled “HIGH-STRENGTH POLYURETHANE ADHESIVE, METHOD FOR PREPARING THE SAME, AND USE THEREOF,” the entire contents of which are incorporated herein by reference for all purposes.

### TECHNICAL FIELD

The present invention relates to the field of adhesives, and in particular to a high-strength polyurethane adhesive, a method for preparing the same, and use thereof.

### BACKGROUND OF THE INVENTION

Polyurethane adhesives are widely used in many fields due to their excellent adhesion properties, flexibility, and chemical resistance. Oxygen and nitrogen atoms in polyurethane adhesives jointly contribute to adhesion in various ways, such as by forming polar groups, increasing cohesive energy, promoting chemical reactions, and affecting thermal stability. These mechanisms enable polyurethane adhesives to firmly bond various materials and maintain stable performance.

Synthetic leather is widely used in shoe materials, luggage, furniture, and other fields, and its performance depends largely on the quality of the adhesive. However, conventional polyurethane adhesives are prone to debonding, peeling, and other problems associated with insufficient adhesion performance in humid environments or environments involving contact with organic solvents. In particular, in polar or nonpolar organic solvents such as toluene, xylene, and ethanol, conventional polyurethane adhesives are easily swollen or dissolved, causing the adhesive to soften and lose strength, with degradation being accelerated especially at high temperature.

In addition, polyurethane adhesives in the prior art are mostly prepared using organic solvents, resulting in environmental pollution and health hazards. Although some references report preparing sulfur-containing polyurethane adhesives using disulfide bonds as crosslinking agents or thiocarbamates, thereby improving adhesion, such adhesives exhibit poor high-temperature stability and mechanical properties, their preparation methods are complicated, and their water resistance and solvent resistance still need to be improved.

### SUMMARY OF THE INVENTION

An objective of the present invention is to provide a high-strength polyurethane adhesive, a method for preparing the same, and use thereof, so as to overcome the deficiencies of the prior art. By introducing sulfur into polymer molecular chains, the adhesion performance between a base fabric (backing fabric) and a coating is significantly improved, while water resistance and solvent resistance are also greatly improved. The preparation process is solvent-free and meets environmental protection requirements.

The overall inventive concept adopted by the present invention is as follows:

The present invention is intended to solve the problems of deterioration of bonding performance and interlayer debonding failure of existing polyurethane adhesives in high-humidity, high-temperature, and organic-solvent environments. Conventional polyurethane adhesives mostly use hydroxy-functional polyols and isocyanates as the main reaction system. Although the structure is flexible, the crosslinking density is insufficient and the adhesives are susceptible to attack by moisture or polar solvents, resulting in failure of the bonding interface, and they exhibit poor performance especially in structural bonding applications involving synthetic leather, photovoltaics, and metal composites.

To overcome the above technical problems, the present invention provides a ternary-structured polyurethane adhesive system constructed based on a thiol-containing compound and an epoxide compound. The system is prepared through the following steps: reacting a branched polythiol with an epoxide compound to form an epoxide-derived prepolymer having hydroxyl structural units and suitable reactivity, with a catalyst and a neutralizing agent being used to control the degree of reaction; blending the prepolymer with an additional branched polythiol to introduce thiol reaction sites for a subsequent crosslinking reaction; and then reacting the resulting mixture with an isocyanate, preferably a polyfunctional isocyanate, according to a stoichiometric relationship between —N═C═O groups in the isocyanate and active hydrogen groups in the mixture, thereby forming a polyurethane adhesive having a main-chain structure comprising flexible hydroxyl-containing segments, sulfur-containing segments, and carbamate/S-thiocarbamate linkages. After the reaction, the reaction product is subjected to vacuum degassing to obtain a solvent-free adhesive having a uniform structure.

In the above polymerization route, the —N═C═O groups in the isocyanate react with the active hydrogen groups in the mixture. The active hydrogen groups include thiol groups (—SH) in the branched polythiol and hydroxyl groups (—OH) in the epoxide-derived prepolymer. The reaction between —SH and —N═C═O can form S-thiocarbamate linkages, while the reaction between —OH and —N═C═O can form carbamate linkages. The hydroxyl structural units in the epoxide-derived prepolymer help impart flexibility and interfacial adaptability to the molecular chains, and the branched polythiol provides thiol reaction sites. After the two components react with the isocyanate, a polyurethane network incorporating sulfur-containing segments, carbamate linkages, and S-thiocarbamate linkages is formed, thereby increasing the degree of crosslinking, cohesive strength, and interfacial bonding capability of the polymer network.

In the present invention, the amount of the isocyanate added is determined according to a ratio between the molar amount of —N═C═O groups in the isocyanate and the molar amount of active hydrogen groups in the mixture. By controlling an R value, namely the molar ratio of the —N═C═O groups to the active hydrogen groups, within a range of 0.8-1.3, especially in the vicinity of 1.05, the relationship between crosslinking density and cohesive strength can be regulated, so that the —N═C═O groups sufficiently react with the —SH/—OH active hydrogen groups, thereby constructing a polyurethane network having both compactness and toughness. The above sulfur-containing segments, carbamate/S-thiocarbamate linkages, and non-covalent interactions such as interchain hydrogen bonds jointly act to improve the bonding stability of the adhesive in high-humidity, high-temperature, and organic-solvent environments, thereby alleviating the problems of deterioration of bonding performance and interlayer debonding failure. To achieve the above objective, the technical solutions of the present invention are as follows:

In a first aspect, the present invention provides a method for preparing a high-strength polyurethane adhesive, comprising the following steps:
(1) mixing a branched polythiol with an epoxide compound, adding a catalyst to conduct a reaction, and then adding a neutralizing agent to terminate the reaction, thereby obtaining an epoxide-derived prepolymer;
(2) mixing the epoxide-derived prepolymer with a branched polythiol, thereby obtaining a mixture;
(3) mixing the mixture with an isocyanate and conducting a reaction to obtain a product, and subjecting the product to degassing treatment to obtain the high-strength polyurethane adhesive; wherein, in step (1), the branched polythiol and the epoxide compound are mixed according to a molar ratio of thiol groups to epoxy groups of 1:(0.1-25). In this step, the ring-opening reaction mechanism between the thiol groups in the branched polythiol and the epoxy groups in the epoxide compound is as follows:

The catalyst activates the thiol groups (—SH) in the branched polythiol and abstracts a proton (H⁺) from the thiol groups to generate thiolate anions (S⁻) and a protonated catalyst. Because thiolate anions are very strong nucleophiles, they are more reactive than neutral thiol groups.

A thiolate anion attacks a less substituted carbon atom (i.e., a primary carbon atom) in the epoxide compound, causing an SN2-type ring-opening reaction, such that ring opening of the epoxy group in the epoxide compound forms an intermediate having a β-hydroxy thioether structure.

The intermediate having the β-hydroxy thioether structure undergoes proton transfer with the protonated catalyst to form a stable product, namely the epoxide-derived prepolymer.

As used in the present application, the term “epoxide-derived prepolymer” refers to a prepolymer obtained by a ring-opening reaction between a branched polythiol and an epoxide compound and containing β-hydroxy thioether structural units.

It can be seen from the above mechanism of the ring-opening reaction between the thiol and the epoxide that, during the reaction between the branched polythiol and the epoxide compound, the groups that actually participate in the reaction are thiol groups of the branched polythiol, which undergo a ring-opening reaction with epoxy groups in the epoxide compound. Mixing the branched polythiol and the epoxide compound according to a molar ratio of thiol groups to epoxy groups of 1:(0.1-25) can ensure that the high-strength polyurethane adhesive is obtained in the subsequent reaction process; the specific analysis is as follows:

When the branched polythiol and the epoxide compound are mixed according to a molar ratio of thiol groups to epoxy groups of 1:0.1, i.e., when thiol groups are present in excess relative to epoxy groups, 0.9 mol of thiol groups remains in excess and does not participate in the reaction, resulting in a reduced hydroxyl-group content in the epoxide-derived prepolymer synthesized by ring opening. Because hydroxyl groups are more reactive than thiol groups, reaction with an isocyanate can yield a polyurethane adhesive having relatively good strength.

When the molar ratio of the thiol groups to the epoxy groups is 1:25, hydroxyl groups continue to undergo a ring-opening reaction with the epoxide, the molecular-chain length increases, the sulfur content decreases, and the viscosity is relatively high. In a solvent-free polyurethane adhesive, the viscosity is excessively high, and although small bubbles may be present during bonding, the adhesive still has good adhesion strength.

In some other embodiments, in step (1), the branched polythiol and the epoxide compound are mixed according to a molar ratio of thiol groups to epoxy groups of 1:(0.8-1.5).

In some other embodiments, in step (1), the branched polythiol and the epoxide compound are mixed according to a molar ratio of thiol groups to epoxy groups of 1:(1.0-1.1).

In some other embodiments, in step (1), when the branched polythiol and the epoxide compound are mixed according to a molar ratio of thiol groups to epoxy groups of 1:1.05, the resulting epoxide-derived prepolymer has a relatively high hydroxyl-group content and an appropriate viscosity, no small bubbles are generated during bonding, and the adhesion strength is relatively high.

In some preferred embodiments, the branched polythiol is one selected from the group consisting of 2,3-bis((2-mercaptoethyl)thio)-1-propanethiol (CAS No. 131538-00-6), trimethylolpropane tris(3-mercaptopropionate) (CAS No. 33007-83-9), and 1,3,5-tris(mercaptomethyl)benzene (CAS No. 38460-57-0).

The epoxide compound is one selected from the group consisting of ethylene oxide, propylene oxide, and epoxypentane. As used in the present application, the term “epoxypentane” refers to 1,2-epoxypentane, also known as propyloxirane or 2-propyloxirane; its English name is “1,2-Epoxypentane” or “Propyloxirane,” and its CAS number is 1003-14-1. The foregoing names and CAS number are used to facilitate identification of the compound and do not limit its supplier, commercial source, or purity specification.

In some preferred embodiments, the branched polythiol is 2,3-bis((2-mercaptoethyl)thio)-1-propanethiol. As used in the present application, “2,3-bis((2-mercaptoethyl)thio)-1-propanethiol” corresponds to CAS No. 131538-00-6, has the English name “1-Propanethiol, 2,3-bis[(2-mercaptoethyl)thio]-,” and may also be referred to as “2,3-bis((2-mercaptoethyl)thio)-1-propanethiol.” The above CAS number and English names are provided to facilitate identification of the compound and do not limit its supplier or commercial source.

In some preferred embodiments, the epoxide compound is propylene oxide. Propylene oxide has a highly strained three-membered epoxy ring and a short substituent, which facilitates a ring-opening reaction with a thiol and formation of a β-hydroxy thioether structure. Compared with 1,2-epoxypentane, a segment derived from 1,2-epoxypropane is shorter and the molecular chain is relatively more compact, which helps maintain stronger polar interactions and form a tighter interfacial bonding structure at an interface. The longer alkyl-chain structure of 1,2-epoxypentane may increase molecular flexibility and reduce polar interactions, thereby weakening adhesion.

In some other embodiments, in step (1), the catalyst is one selected from the group consisting of triethylenediamine (DABCO, 1,4-diazabicyclo[2.2.2]octane), triethylamine, N,N-dimethylethanolamine, N,N-dimethylcyclohexylamine, and benzyltrimethylammonium hydroxide.

The neutralizing agent is one selected from the group consisting of hydrochloric acid, phosphoric acid, formic acid, acetic acid, and aminoacetic acid (glycine).

The catalyst is added in an amount of 2 to 6 parts per thousand by mass, based on the total mass of the branched polythiol and the epoxide compound.

The neutralizing agent is added in an amount of 2 to 6 parts per thousand by mass, based on the total mass of the branched polythiol and the epoxide compound.

In some other embodiments, in step (1), the catalyst is benzyltrimethylammonium hydroxide; and the neutralizing agent is phosphoric acid.

The catalyst is added in an amount of 5 parts per thousand by mass, based on the total mass of the branched polythiol and the epoxide compound.

The neutralizing agent is added in an amount of 5 parts per thousand by mass, based on the total mass of the branched polythiol and the epoxide compound.

In some other embodiments, in step (1), the reaction temperature is 5-20 °C, and the reaction time is 2-6 h.

After the reaction is terminated, the method further comprises stirring for an additional 5-10 min.

In some other embodiments, in step (2), the epoxide-derived prepolymer and the branched polythiol are mixed according to a molar ratio of hydroxyl groups in the epoxide-derived prepolymer to thiol groups in the branched polythiol of (2-6):10.

The mixing temperature is 45-55 °C, and the mixing time is 5-10 min.

In some other embodiments, in step (3), the mixture and the isocyanate are mixed according to a molar ratio of —N═C═O groups in the isocyanate to active hydrogen groups in the mixture of 0.8-1.3.

The active hydrogen groups are —SH and —OH.

In the present invention, the amount of the isocyanate added is usually not uniformly defined by a fixed mass, but is determined according to a ratio between the molar amount of —N═C═O groups in the isocyanate and the molar amount of active hydrogen groups in the mixture. The active hydrogen groups in the mixture include hydroxyl groups in the epoxide-derived prepolymer and thiol groups in the branched polythiol. By controlling the molar ratio of the —N═C═O groups to the active hydrogen groups, namely the R value, the crosslinking density, cohesive strength, and bonding performance of the polyurethane network can be regulated.

Further, when the R value is too low, the —N═C═O groups are insufficient relative to the active hydrogen groups, which may result in an insufficient crosslinking degree and reduced cohesive strength of the polymer network. When the R value is too high, excessive isocyanate reactive groups may be present in the system, affecting uniformity of the network structure and bonding stability. Therefore, by controlling the R value within a range of 0.8-1.3, the isocyanate reactive groups and the —SH/—OH active hydrogen groups can be maintained in an appropriate stoichiometric relationship, thereby obtaining a polyurethane adhesive having both strength and toughness. In some other embodiments, in step (3), the reaction temperature is 60-90 °C, and the reaction time is 2-4 h.

The degassing treatment is performed under vacuum at 65-75 °C for 30-60 min.

In a second aspect, the present invention provides a high-strength polyurethane adhesive prepared by the method according to the first aspect.

In a third aspect, the present invention provides use of the high-strength polyurethane adhesive according to the second aspect in leather, building materials, photovoltaics, automobiles, and encapsulation of electronic products.

### Beneficial Effects of the Present Invention

The high-strength polyurethane adhesive prepared according to the present invention has the following beneficial technical effects:
(1) The initial shear strength of the polyurethane adhesive prepared according to the present invention can reach 50 MPa or more, and relatively high shear strength and bonding stability can still be maintained in damp-heat, strongly polar solvent, or nonpolar solvent environments. The adhesive can be used to bond various materials such as leather, metal, and plastic, and is particularly suitable for high-strength bonding between a surface layer and a backing fabric in a dry-laminated synthetic-leather structure.
(2) The adhesive has good boiling-water resistance, acid and alkali resistance, organic-solvent resistance, and low-temperature adaptability (for example, adhesion stability is maintained in a liquid-nitrogen environment).
(3) The entire system is solvent-free, is suitable for environmentally friendly manufacturing processes, and follows the development trend of green adhesive materials. As shown by the data in the Examples, the adhesive prepared under conditions of an appropriate ratio (hydroxyl groups/thiol groups=2-6:10, R=1.05) maintains a stable bonded structure after immersion for several weeks in various polar/nonpolar media, including ethanol, xylene, acetone, and N,N-dimethylformamide (DMF), and exhibits relatively high chemical stability and long-term service capability.

In summary, the present invention employs a synergistic “thiol+epoxide+isocyanate” strategy in molecular structure design to construct a polyurethane structural network with multilevel crosslinking, thereby providing a solvent-free solution having relatively high bonding stability for structural bonding, composite-material bonding, and specialized application environments, such as humid, corrosive, or swelling environments.

### BRIEF DESCRIPTION OF THE DRAWINGS

The accompanying drawings forming a part of the specification are provided for a further understanding of the present invention. The illustrative embodiments of the present invention and the description thereof are used to explain the present invention and are not intended to unduly limit the present invention.

FIG. 1 is a derivative thermogravimetric (DTG) plot of the high-strength polyurethane adhesive in Example 1 of the present invention.

FIG. 2 is a schematic diagram showing the test procedure for the macroscopic adhesion behavior of the high-strength polyurethane adhesive in Example 1 of the present invention in liquid nitrogen.

FIG. 3 shows shear strength test results at different R values for Example 1 and Example 5 of the present invention.

FIG. 4A is a graph showing shear strength test results for the high-strength polyurethane adhesives in Comparative Example 1, Example 1, and Example 2 of the present invention after immersion in deionized water for different times.

FIG. 4B is a graph showing shear strength test results for the high-strength polyurethane adhesives in Comparative Example 1, Example 1, and Example 2 of the present invention after immersion in a 3.5% NaCl solution for different times.

FIG. 4C is a graph showing shear strength test results for the high-strength polyurethane adhesives in Comparative Example 1, Example 1, and Example 2 of the present invention after immersion in xylene for different times.

FIG. 4D is a graph showing shear strength test results for the high-strength polyurethane adhesives in Comparative Example 1, Example 1, and Example 2 of the present invention after immersion in ethanol for different times.

FIG. 4E is a graph showing shear strength test results for the high-strength polyurethane adhesives in Comparative Example 1, Example 1, and Example 2 of the present invention after immersion in acetone for different times.

FIG. 4F is a graph showing shear strength test results for the high-strength polyurethane adhesive in Example 1 of the present invention after immersion in N,N-dimethylformamide for different times.

In FIGS. 4A to 4E, the three bars corresponding to each time point represent, from left to right, Comparative Example 1, Example 1, and Example 2.

FIG. 5 is a graph showing an acid and alkali resistance test of the high-strength polyurethane adhesive in Example 1 of the present invention.

FIG. 6 is a graph showing lap shear strength test results for the high-strength polyurethane adhesive in Example 1 of the present invention after immersion in a potassium permanganate solution.

FIG. 7 is a graph showing a high-temperature boiling-water test of the high-strength polyurethane adhesive in Example 1 of the present invention.

### DETAILED DESCRIPTION

Those skilled in the art will understand that the following Examples are merely used to illustrate the present invention and should not be regarded as limiting the scope of the present invention. Where specific conditions are not indicated in the Examples, the procedures were carried out under conventional conditions in the art or under conditions recommended by the manufacturer. Components for which no manufacturer or product model is indicated are conventional commercially available products. For components metered based on reactive groups, those skilled in the art can determine the amount added according to the molar amount of the corresponding reactive groups.

### Example 1

A method for preparing a high-strength polyurethane adhesive specifically comprises the following steps:
(1) 37.2 g of 2,3-bis((2-mercaptoethyl)thio)-1-propanethiol and 26.16 g of propylene oxide were mixed according to a molar ratio of thiol groups to epoxy groups of 1:1.05, and 0.3168 g of benzyltrimethylammonium hydroxide was added as a catalyst in an amount of 5 parts per thousand by mass, based on the total mass of the 2,3-bis((2-mercaptoethyl)thio)-1-propanethiol and the propylene oxide. After the mixture was stirred and reacted at 10 °C for 5 h, 0.3168 g of phosphoric acid was added as a neutralizing agent in an amount of 5 parts per thousand by mass, based on the total mass of the 2,3-bis((2-mercaptoethyl)thio)-1-propanethiol and the propylene oxide, and the mixture was stirred for an additional 10 min to obtain an epoxide-derived prepolymer.
(2) 5.72 g of the epoxide-derived prepolymer and 26.76 g of 2,3-bis((2-mercaptoethyl)thio)-1-propanethiol were mixed according to a molar ratio of hydroxyl groups in the epoxide-derived prepolymer to thiol groups in the 2,3-bis((2-mercaptoethyl)thio)-1-propanethiol of 2:10, and were then stirred and reacted at 50 °C for 10 min to obtain a mixture.
(3) The mixture and an isocyanate were metered and mixed at R=1.05, wherein R is the molar ratio of —N═C═O groups in the isocyanate to active hydrogen groups in the mixture, and the active hydrogen groups are —SH and —OH. After mixing, the reaction was conducted at 75 °C for 4 h to obtain a product. The product was degassed under vacuum at 70 °C for 30 min to obtain a high-strength polyurethane adhesive.

A method for bonding the high-strength polyurethane adhesive to a substrate is as follows:

The high-strength polyurethane adhesive was uniformly coated on a surface of a substrate (e.g., a steel substrate, leather, or synthetic leather) at a coating amount of 70 g/m², and a polyurethane (PU) resin was coated on a surface of release paper at a coating amount of 100 g/m². The two were then hot-pressed at 100 °C under a 500 g weight for 2 h to cure the adhesive. After the adhesive was cured, the release paper was peeled off, thereby completing bonding of the high-strength polyurethane adhesive to the substrate.

### Example 2

The difference from Example 1 was that, in step (2), the epoxide-derived prepolymer and 2,3-bis((2-mercaptoethyl)thio)-1-propanethiol were mixed according to a molar ratio of hydroxyl groups in the epoxide-derived prepolymer to thiol groups in the 2,3-bis((2-mercaptoethyl)thio)-1-propanethiol of 4:10;

The other preparation steps were the same as those in Example 1.

### Example 3

The difference from Example 1 was that, in step (2), the epoxide-derived prepolymer and 2,3-bis((2-mercaptoethyl)thio)-1-propanethiol were mixed according to a molar ratio of hydroxyl groups in the epoxide-derived prepolymer to thiol groups in the 2,3-bis((2-mercaptoethyl)thio)-1-propanethiol of 6:10;

The other preparation steps were the same as those in Example 1.

### Example 4

The difference from Example 1 was that, in step (2), the epoxide-derived prepolymer and 2,3-bis((2-mercaptoethyl)thio)-1-propanethiol were mixed according to a molar ratio of hydroxyl groups in the epoxide-derived prepolymer to thiol groups in the 2,3-bis((2-mercaptoethyl)thio)-1-propanethiol of 10:0;

The other preparation steps were the same as those in Example 1.

### Example 5

The difference from Example 1 was that, in step (3), the mixture and the isocyanate were respectively mixed at R=0.85, 0.95, 1.15, and 1.25;

The other preparation steps were the same as those in Example 1.

Example 5 was used to illustrate the effect of the molar ratio of —N═C═O groups in the isocyanate to active hydrogen groups in the mixture, namely the R value, on the bonding strength of the obtained polyurethane adhesive under otherwise substantially identical preparation conditions.

### Example 6

The difference from Example 1 was that, in steps (1) and (2), trimethylolpropane tris(3-mercaptopropionate) was used to replace 2,3-bis((2-mercaptoethyl)thio)-1-propanethiol, and the other preparation steps were the same as those in Example 1.

### Example 7

The difference from Example 1 was that, in steps (1) and (2), 1,3,5-tris(mercaptomethyl)benzene was used to replace 2,3-bis((2-mercaptoethyl)thio)-1-propanethiol, and the other preparation steps were the same as those in Example 1.

### Example 8

The difference from Example 1 was that, in step (1), the molar ratios of thiol groups to epoxy groups were 1:0.1 and 1:25, respectively;

The other preparation steps were the same as those in Example 1.

### Example 9

The difference from Example 1 was that, in step (1), epoxypentane (i.e., 1,2-epoxypentane) was used in place of propylene oxide, and the other preparation steps were the same as those in Example 1.

### Comparative Example 1

The difference from Example 1 was that, in step (2), the epoxide-derived prepolymer and 2,3-bis((2-mercaptoethyl)thio)-1-propanethiol were mixed according to a molar ratio of hydroxyl groups in the epoxide-derived prepolymer to thiol groups in the 2,3-bis((2-mercaptoethyl)thio)-1-propanethiol of 0:10;

The other preparation steps were the same as those in Example 1.

### Comparative Example 2

The difference from Example 1 was that, in steps (1) and (2), 1,3-propanedithiol was used to replace 2,3-bis((2-mercaptoethyl)thio)-1-propanethiol, and the other preparation steps were the same as those in Example 1.

### Performance Tests

### 1. Derivative Thermogravimetric (DTG) Analysis

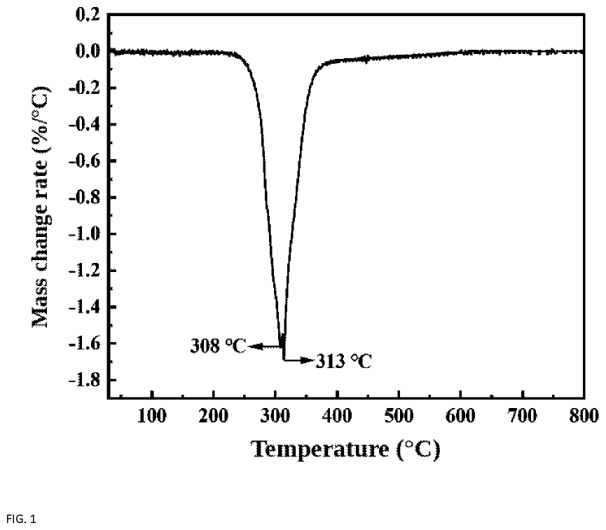

A thermogravimetric analyzer (TGA) was used to determine the thermal stability of the sample of Example 1 under a nitrogen atmosphere, with the nitrogen flow rate controlled at 50 mL·min⁻¹. The sample was cut into small solid particles weighing 5-10 mg and placed in an alumina thermal-analysis crucible. The heating/cooling rate was 10 °C·min⁻¹, and the sample was heated from 30 °C to 800 °C. FIG. 1 is a DTG plot of the high-strength polyurethane adhesive of Example 1 of the present invention.

The results are shown in FIG. 1. The sample of Example 1 had maximum thermal decomposition temperatures of 308 °C and 313 °C, which corresponded to the maximum decomposition temperatures of the S-thiocarbamate linkages and the carbamate linkages, respectively. The larger atomic radius and lower electronegativity of sulfur atoms make C—S bonds easier to break than C—O bonds, thereby resulting in a lower decomposition temperature.

### 2. Macroscopic Adhesion Behavior in Liquid Nitrogen

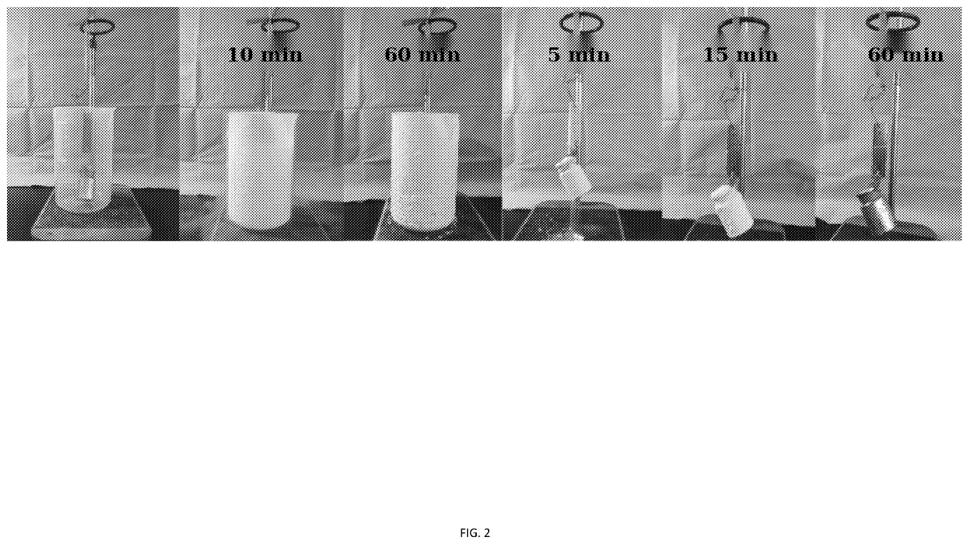

The high-strength polyurethane adhesive prepared in Example 1 was used to bond a steel substrate, and a 500 g weight was suspended beneath the bonded assembly. The bonded assembly was then placed in liquid nitrogen for 1 h, with the bonded region kept below the surface of the liquid nitrogen throughout the treatment. After the liquid-nitrogen treatment, the bonded assembly was removed and continued to be suspended during warming, and its macroscopic adhesion state was observed. FIG. 2 shows the macroscopic adhesion behavior during the liquid-nitrogen treatment and warming process. As shown in FIG. 2, after the low-temperature liquid-nitrogen treatment and warming, the bonded assembly remained suspended under load without obvious detachment or debonding, indicating that the polyurethane adhesive prepared in Example 1 had good macroscopic adhesion stability during the liquid-nitrogen treatment and subsequent warming.

### 3. Shear Strength Test

An XWN-20 microcomputer-controlled electronic universal testing machine was used, a single-lap shear test was performed, and the tensile speed was 10 mm·min⁻¹. The adhesion strength was obtained by dividing the force measured during the test by the bonded area of the substrate, and three replicate samples were used for each measurement.

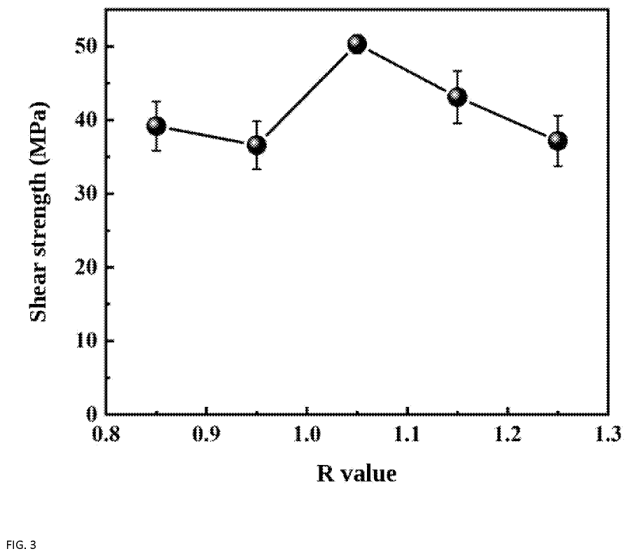

FIG. 3 shows shear strength test results at different R values for Example 1 and Example 5 of the present invention. The lap shear test results show that the shear strengths at R=0.85, 0.95, 1.05, 1.15, and 1.25 were 39.17±3.35, 36.57±3.27, 50.31±1.22, 43.105±3.54, and 37.155±3.43 MPa, respectively. When the molar ratio of —N═C═O groups to active hydrogen groups was close to 1, the reaction proceeded relatively completely, and hydrogen-bonding interactions between carbamate and S-thiocarbamate linkages in the molecular chains were enhanced. Accordingly, when R=1.05, the lap shear strength was the highest, at 50.31±1.22 MPa. These results show that the R value has a significant effect on the crosslinking density and cohesive strength of the polyurethane network. When the R value is in the vicinity of 1.05, the stoichiometric relationship between the —N═C═O groups and the —SH/—OH active hydrogen groups is relatively suitable, which facilitates the formation of a polyurethane network having both strength and toughness.

4. Shear Strength Tests after Immersion in Different Solvents for Different Times

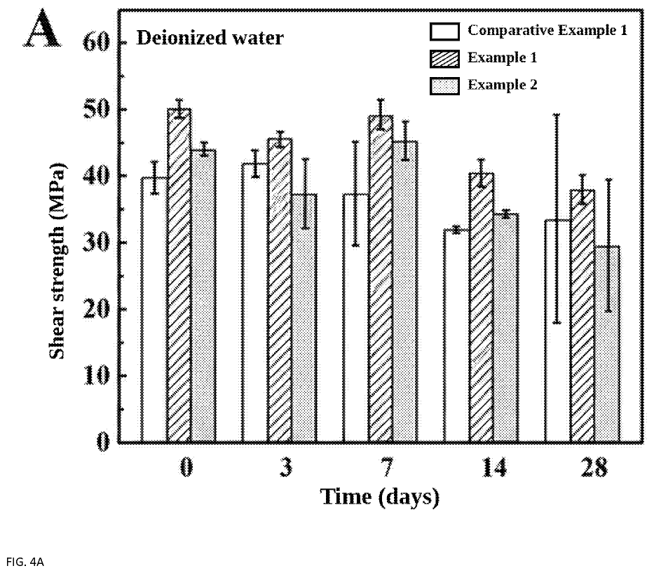

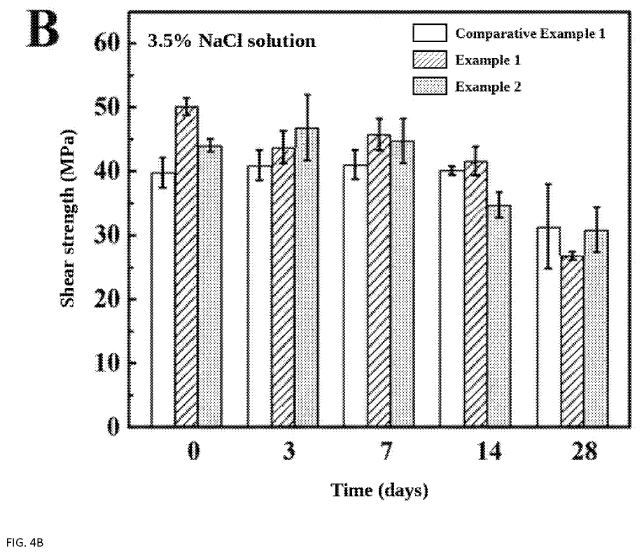

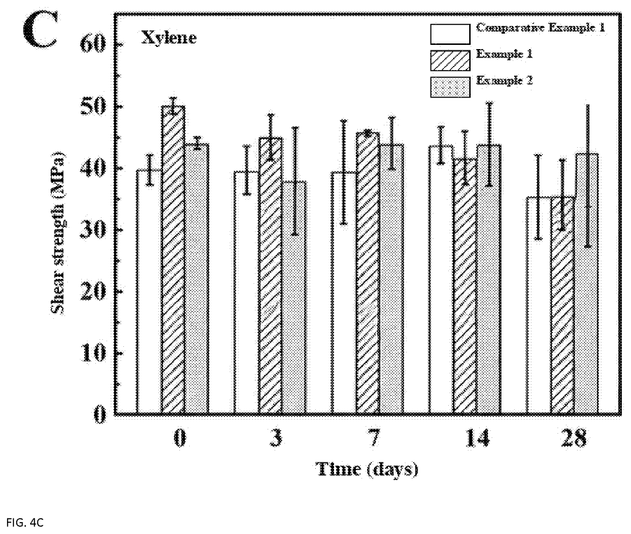

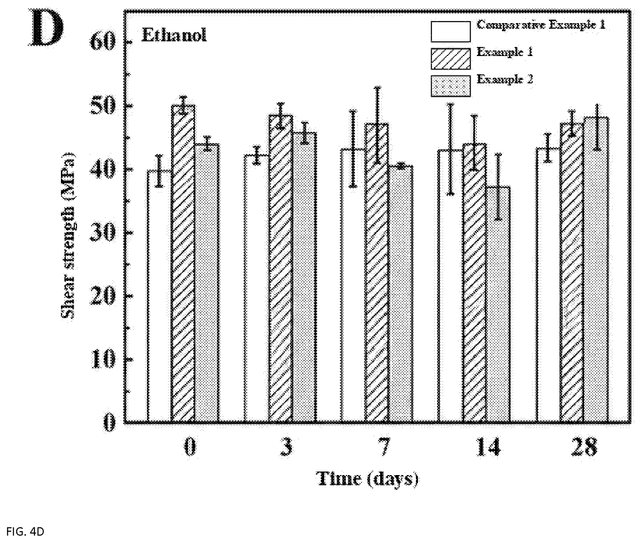

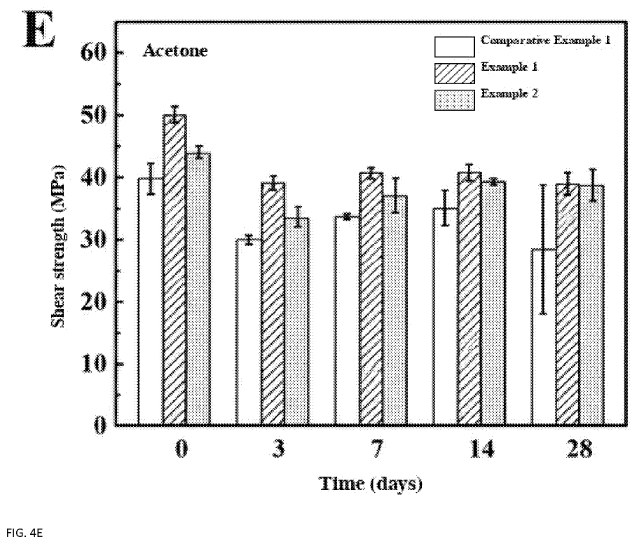

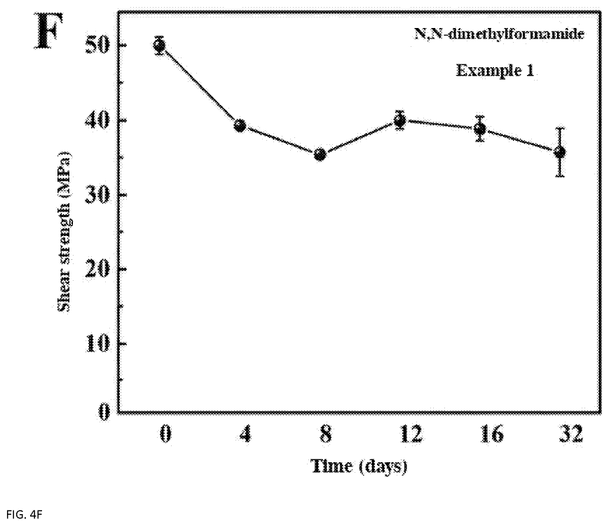

Steel substrates lap-bonded using the adhesives of Example 1, Example 2, and Comparative Example 1 were separately placed in deionized water, ethanol, xylene, a 3.5% NaCl solution, acetone, and N,N-dimethylformamide (DMF) for immersion tests. Samples placed in deionized water, ethanol, xylene, the 3.5% NaCl solution, and acetone were immersed at room temperature for 0-28 days, and samples placed in N,N-dimethylformamide (DMF) were immersed at room temperature for 0-60 days. After immersion, an XWN-20 microcomputer-controlled electronic universal testing machine was used, a single-lap shear test was performed, and the tensile speed was 10 mm·min⁻¹. The adhesion strength was obtained by dividing the force measured during the test by the bonded area of the substrate, and three replicate samples were used for each measurement. The lap shear strength test results at different times are shown in FIGS. 4A to 4F, wherein FIGS. 4A to 4E respectively show the test results of Comparative Example 1, Example 1, and Example 2 in deionized water, the 3.5% NaCl solution, xylene, ethanol, and acetone, and FIG. 4F shows the test results of Example 1 in DMF.

It can be seen from FIGS. 4A to 4E that the samples of Example 1, Example 2, and Comparative Example 1 all exhibited good water resistance and solvent resistance in deionized water, ethanol, xylene, the 3.5% NaCl solution, and acetone, wherein Example 1 had better lap shear strength and stability. After the sample of Example 1 was immersed at room temperature for 28 days in deionized water, ethanol, xylene, the 3.5% NaCl solution, and acetone, the lap shear strengths thereof were 38.15±2.08 MPa, 47.49±1.81 MPa, 35.97±5.62 MPa, 27.04±0.55 MPa, and 39.18±1.48 MPa, respectively. As can be seen from FIG. 4F, the sample of Example 1 remained bonded after immersion in DMF at room temperature for 60 days; after immersion in DMF for 32 days, its lap shear strength still remained about 71% of the initial lap shear strength, i.e., 35.85±3.25 MPa.

### 5. Acid and Alkali Resistance Test

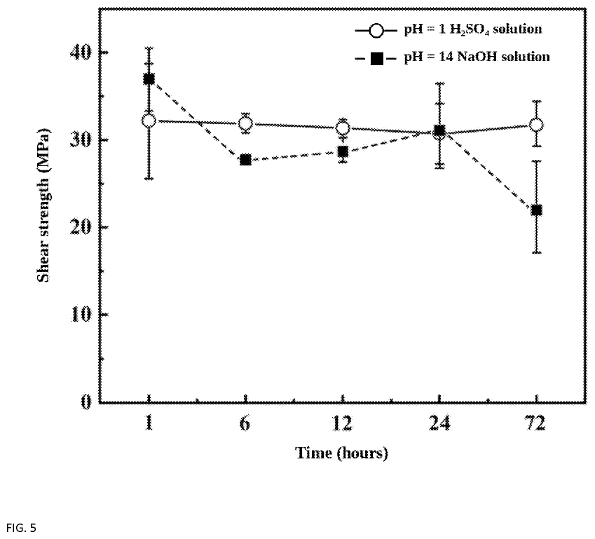

FIG. 5 shows an acid and alkali resistance test of the high-strength polyurethane adhesive in Example 1 of the present invention. It can be seen from FIG. 5 that the adhesive prepared in Example 1 was used to lap-bond steel substrates, and the samples were respectively immersed in a sulfuric acid solution having pH=1 and a sodium hydroxide solution having pH=14 to evaluate acid and alkali resistance. The experimental results show that, in the sulfuric acid solution, the samples maintained stable adhesion strength from 1 h to 72 h. After 72 h, the adhesion strength was still as high as 31.87±2.56 MPa, and the retention rate relative to the initial lap shear strength reached 63.35%. In addition, the samples also exhibited good resistance in an alkaline environment. After immersion in the sodium hydroxide solution for 24 h, the adhesion strength was 31.66±4.82 MPa, slightly higher than the corresponding value in the sulfuric acid solution. After 72 h, the adhesion strength was still maintained at 22.41±5.21 MPa.

6. Lap Shear Strength after Immersion in a Potassium Permanganate Solution

After immersion in a potassium permanganate solution, an XWN-20 microcomputer-controlled electronic universal testing machine was used, a single-lap shear test was performed, and the tensile speed was 10 mm·min⁻¹. The adhesion strength was obtained by dividing the force measured during the test by the bonded area of the substrate, and three replicate samples were used for each measurement.

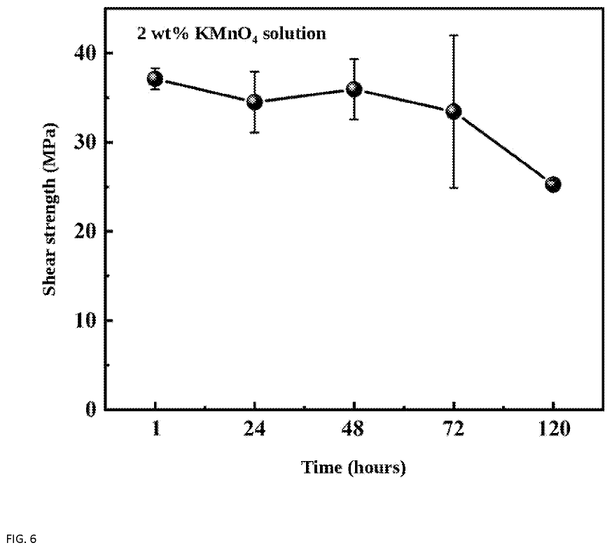

FIG. 6 shows the lap shear strength of the high-strength polyurethane adhesive in Example 1 of the present invention after immersion in a potassium permanganate solution. As shown in FIG. 6, the sample exhibited good adhesion strength after immersion in a 2 wt % potassium permanganate (KMnO₄) solution for 1-72 h, and its adhesion strength after immersion for 72 h was 33.44 MPa. Further testing showed that, after immersion in the 2 wt % KMnO₄ solution for 120 h, the sample still retained more than 50% of its adhesion strength.

### 7. High-Temperature Boiling-Water Resistance Performance

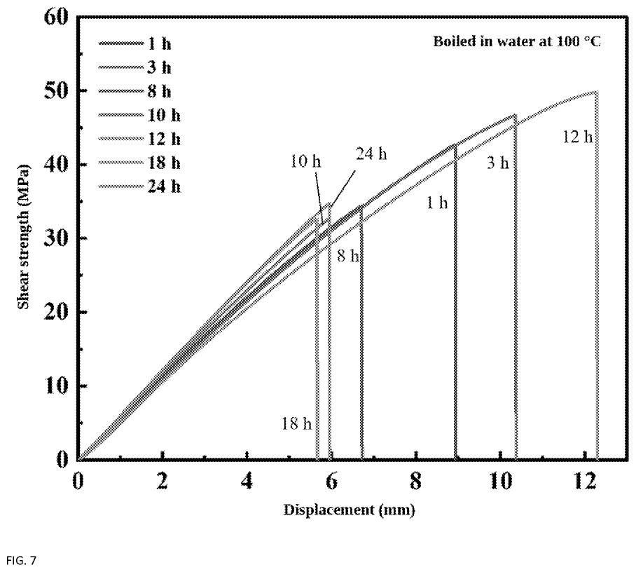

The stainless steel bonded in Example 1 was subjected to high-temperature boiling-water treatment. The sample was placed in distilled water at 100 °C and boiled for respective periods of 1 h, 3 h, 8 h, 10 h, 12 h, 18 h, and 24 h. After the heating was stopped, the lap shear strength was tested. As shown in FIG. 7, the measured lap shear strengths were 37.56±2.22, 38.23±2.27, 33.12±1.81, 30.19±2.14, 31.27±2.81, 30.81±1.82, and 32.63±2.98 MPa, respectively. The results show that the sample still maintained good mechanical properties after high-temperature boiling-water treatment.

8. The water resistance, adhesion, corrosion resistance, and high-temperature resistance of the samples prepared in the Examples and Comparative Examples are shown in Table 1. The test method for water resistance was as follows: a sample was immersed in deionized water for 7 days, and then the lap shear strength was tested. The test method for corrosion resistance was as follows: a sample was immersed in 2 wt % potassium permanganate for 72 h, and then the lap shear strength was tested. The test method for high-temperature resistance was as follows: a sample was heated in a muffle furnace at 265 °C for 1 h, and then the lap shear strength was tested.

TABLE 1
Water resistance, adhesion, corrosion resistance, and high-temperature
resistance of samples prepared in Examples and Comparative Examples

| | | | | | High- |
|---|---|---|---|---|---|
| | | Adhesion | Water | Corrosion | temperature |
| | | strength | resistance | resistance | resistance |
| Sample | | (MPa) | (MPa) | (MPa) | (MPa) |
| Example 1 | | 50.31 ± 1.22 | 49.36 ± 2.16 | 35.94 ± 3.39 | 39.76 ± 0.68 |
| Example 2 | | 43.92 ± 5.28 | 45.375 ± 2.62 | 24.63 ± 3.29 | 35.72 ± 2.72 |
| Example 3 | | 24.43 ± 4.74 | 14.37 ± 3.79 | 13.92 ± 1.32 | 16.92 ± 2.21 |
| Example 4 | | 37.71 ± 1.77 | 26.93 ± 2.19 | 23.71 ± 0.83 | 30.88 ± 0.79 |
| Example 5 | R = 0.85 | 39.17 ± 3.35 | 28.17 ± 1.75 | 30.47 ± 2.39 | 31.97 ± 4.05 |
| | R = 0.95 | 36.57 ± 3.27 | 27.37 ± 2.55 | 28.52 ± 4.23 | 32.53 ± 3.67 |
| | R = 1.15 | 43.11 ± 3.54 | 40.09 ± 1.14 | 37.51 ± 2.34 | 36.11 ± 3.74 |
| | R = 1.25 | 37.16 ± 3.43 | 31.26 ± 2.73 | 27.01 ± 2.73 | 31.16 ± 2.49 |
| Example 6 | | 40.14 ± 1.22 | 34.33 ± 1.53 | 27.24 ± 2.79 | 33.37 ± 1.77 |
| Example 7 | | 38.69 ± 1.10 | 31.68 ± 0.58 | 26.81 ± 1.92 | 31.91 ± 1.70 |
| Example 8 | 1:0.1 | 37.91 ± 1.77 | 35.11 ± 0.94 | 26.10 ± 2.01 | 27.57 ± 2.55 |
| | 1:25 | 36.11 ± 0.88 | 34.67 ± 1.29 | 30.87 ± 1.82 | 30.97 ± 2.11 |

| | | | | |
|---|---|---|---|---|
| Example 9 | 41.18 ± 1.41 | 39.21 ± 0.69 | 32.57 ± 2.32 | 35.94 ± 1.66 |
| Comparative Example 1 | 36.22 ± 2.11 | 33.42 ± 7.70 | 23.11 ± 0.71 | 25.44 ± 3.33 |
| Comparative Example 2 | 19.68 ± 3.59 | 8.61 ± 3.29 | 6.39 ± 2.59 | 12.61 ± 2.91 |

It can be seen from Table 1 that introducing sulfur into the polymer, regulating the branched topology, and controlling an appropriate ratio between the thiol and the epoxide-derived prepolymer facilitate improvement of the adhesion strength, high-temperature resistance, water resistance, and corrosion resistance of the adhesive. In Example 8, when the branched polythiol and the epoxide compound were mixed according to a molar ratio of thiol groups to epoxy groups of 1:0.1, i.e., when thiol groups were present in excess relative to epoxy groups, 0.9 mol of thiol groups remained in excess and did not participate in the reaction, resulting in a reduced hydroxyl-group content in the epoxide-derived prepolymer synthesized by ring opening. Because hydroxyl groups are more reactive than thiol groups, reaction with an isocyanate can yield a polyurethane adhesive having relatively good strength. When the molar ratio of thiol groups to epoxy groups was 1:25, hydroxyl groups continued to undergo a ring-opening reaction with the epoxide, the molecular-chain length increased, the sulfur content decreased, and the viscosity was relatively high. In a solvent-free polyurethane adhesive, the viscosity was excessively high, and small bubbles were generated during bonding, causing the adhesion strength to be slightly lower than that of Example 1, in which the molar ratio of thiol groups to epoxy groups was 1:1.05. In Example 9, epoxypentane (i.e., 1,2-epoxypentane) was used as the epoxide compound. Compared with the propylene oxide used in Example 1, the long-chain structure of 1,2-epoxypentane increased molecular flexibility, reduced polar interactions, and weakened adhesion.

The above tests show that conventional polyurethane adhesives have relatively poor acid and alkali resistance and are susceptible to oxidative degradation by potassium permanganate, whereas the adhesive of the present invention improves acid resistance, alkali resistance, and oxidation resistance by introducing epoxide-derived hydroxyl/thioether structural units and a sulfur-containing polyurethane network. The test results above show that the adhesive still has relatively high bonding stability in harsh chemical environments such as acidic, alkaline, and oxidizing media.

The foregoing descriptions are merely preferred embodiments of the present invention and are not intended to limit the present invention. For those skilled in the art, the present invention may have various modifications and variations. Any modifications, equivalent substitutions, improvements, and the like made within the spirit and principles of the present invention shall fall within the protection scope of the present invention.

1. A method for preparing a high-strength polyurethane adhesive, comprising:
(1) mixing a branched polythiol with an epoxide compound, adding a catalyst to conduct a reaction, and then adding a neutralizing agent to terminate the reaction, thereby obtaining an epoxide-derived prepolymer;
(2) mixing the epoxide-derived prepolymer with a branched polythiol, thereby obtaining a mixture; and
(3) mixing the mixture with an isocyanate and conducting a reaction, thereby obtaining a product, and subjecting the product to degassing treatment to obtain the high-strength polyurethane adhesive;
in step (1), the branched polythiol and the epoxide compound are mixed according to a molar ratio of thiol groups to epoxy groups of 1:(0.1-25);
in step (1), the branched polythiol is one selected from the group consisting of 2,3-bis((2-mercaptoethyl)thio)-1-propanethiol, trimethylolpropane tris(3-mercaptopropionate), and 1,3,5-tris(mercaptomethyl)benzene;
the epoxide compound is one selected from the group consisting of ethylene oxide, propylene oxide, and epoxypentane;
in step (2), the epoxide-derived prepolymer and the branched polythiol are mixed according to a molar ratio of hydroxyl groups in the epoxide-derived prepolymer to thiol groups in the branched polythiol of (2-4):10; and
in step (3), the mixture and the isocyanate are mixed according to a molar ratio of —N═C═O groups in the isocyanate to active hydrogen groups in the mixture of 0.8-1.3.

2. The method for preparing the high-strength polyurethane adhesive according to claim 1,
wherein, in step (1), the branched polythiol and the epoxide compound are mixed according to a molar ratio of thiol groups to epoxy groups of 1:(0.8-1.5).

3. The method for preparing the high-strength polyurethane adhesive according to claim 1,
wherein, in step (1), the branched polythiol and the epoxide compound are mixed according to a molar ratio of thiol groups to epoxy groups of 1:1.05;
the branched polythiol is 2,3-bis((2-mercaptoethyl)thio)-1-propanethiol; and
the epoxide compound is propylene oxide.

4. The method for preparing the high-strength polyurethane adhesive according to claim 1,
wherein, in step (1), the catalyst is one selected from the group consisting of triethylenediamine, triethylamine, N,N-dimethylethanolamine, N,N-dimethylcyclohexylamine, and benzyltrimethylammonium hydroxide;
the neutralizing agent is one selected from the group consisting of hydrochloric acid, phosphoric acid, formic acid, acetic acid, and aminoacetic acid;
the catalyst is added in an amount of 2 to 6 parts per thousand by mass, based on the total mass of the branched polythiol and the epoxide compound; and
the neutralizing agent is added in an amount of 2 to 6 parts per thousand by mass, based on the total mass of the branched polythiol and the epoxide compound.

5. The method for preparing the high-strength polyurethane adhesive according to claim 4,
wherein, in step (1), the catalyst is benzyltrimethylammonium hydroxide;
the neutralizing agent is phosphoric acid;
the catalyst is added in an amount of 5 parts per thousand by mass, based on the total mass of the branched polythiol and the epoxide compound; and
the neutralizing agent is added in an amount of 5 parts per thousand by mass, based on the total mass of the branched polythiol and the epoxide compound.

6. The method for preparing the high-strength polyurethane adhesive according to claim 1,
wherein, in step (1), the reaction temperature is 5-20 °C, and the reaction time is 2-6 h; and
after the reaction is terminated, the method further comprises continuing stirring for 5 to 10 min.

7. The method for preparing the high-strength polyurethane adhesive according to claim 1,
wherein, in step (2), the mixing temperature is 45-55 °C, and the mixing time is 5-10 min.

8. The method for preparing the high-strength polyurethane adhesive according to claim 1,
wherein, in step (3), the active hydrogen groups are —SH and —OH;
the reaction temperature is 60-90 °C, and the reaction time is 2-4 h; and
the degassing treatment is performed under vacuum at 65-75 °C for 30-60 min.

9. A high-strength polyurethane adhesive prepared by the method according to claim 1.
